(19) United States
(12) Patent Application Publication
(10) Pub. No.: US 2023/0326098 A1
(43) Pub. Date: Oct. 12, 2023

(54) GENERATING A DIGITAL TWIN REPRESENTATION OF AN ENVIRONMENT OR OBJECT

(71) Applicant: FARO Technologies, Inc., Lake Mary, FL (US)

(72) Inventors: Oliver Zweigle, Stuttgart (DE); Aleksej Frank, Kornwestheim (DE); Tobias Böehret, Aidlingen (DE); Matthias Wolke, Korntal-Münchingen (DE)

(21) Appl. No.: 18/124,318

(22) Filed: Mar. 21, 2023

Related U.S. Application Data
(60) Provisional application No. 63/322,370, filed on Mar. 22, 2022.

(51) Int. Cl. G06T 11/00; G01S 17/894; G03B 37/04; G06T 7/60; G06T 3/40

(52) U.S. Cl. CPC G06T 11/003; G01S 17/894; G03B 37/04; G06T 3/4038; G06T 7/60; G06T 2200/32

(57) ABSTRACT

Examples described herein provide a method that includes communicatively connecting a camera to a processing system. The processing system includes a light detecting and ranging (LIDAR) sensor. The method further includes capturing, by the processing system, three-dimensional (3D) coordinate data of an environment using the LIDAR sensor while the processing system moves through the environment. The method further includes capturing, by the camera, a panoramic image of the environment. The method further includes associating the panoramic image of the environment with the 3D coordinate data of the environment to generate a dataset for the environment. The method further includes generating a digital twin representation of the environment using the dataset for the environment.

### CROSS-REFERENCE TO RELATED APPLICATION

The present application claims the benefit of U.S. Provisional Application Serial No. 63/322,370 filed on Mar. 22, 2022, the contents of which are incorporated herein by reference.

### BACKGROUND

The subject matter disclosed herein relates to digital twins, and in particular to generating a digital twin representation of an environment.

A digital twin is a virtual representation (or “twin”) of a physical thing, such as an object, system, environment, and/or the like. Digital twins can be used to virtually represent vehicles, boats/ships, industrial machines, buildings, and/or any other suitable physical object (collectively referred to as “physical objects”). Digital twins are created by capturing data about the physical objects. The data can include three-dimensional (3D) coordinate data and/or image data. The 3D coordinate data be captured by a 3D coordinate measurement device (such as a 3D laser scanner time-of-flight (TOF) coordinate measurement device, a light detection and ranging (LIDAR) device, etc.), a mobile mapping device, and/or the like, including combinations and/or multiples thereof. The image data can be captured by any suitable imaging device, such as a digital camera.

Once created, digital twins are useful for analyzing the physical objects so that it can be better understood. For example, an action can be simulated using the digital twin to evaluate how such action may affect the physical objects. As other examples, digital twins are useful for visualizing an object and/or environment, evaluating how multiple objects and/or environments work together, troubleshooting an object, and/or the like including combinations and/or multiples thereof.

While existing digital twin generation techniques are suitable for their intended purposes the need for improvement remains, particularly in providing a system and method having the features described herein.

### BRIEF DESCRIPTION

In one exemplary embodiment, a method is provided. The method includes communicatively connecting a camera to a processing system. The processing system includes a light detecting and ranging (LIDAR) sensor. The method further includes capturing, by the processing system, three-dimensional (3D) coordinate data of an environment using the LIDAR sensor while the processing system moves through the environment. The method further includes capturing, by the camera, a panoramic image of the environment. The method further includes associating the panoramic image of the environment with the 3D coordinate data of the environment to generate a dataset for the environment. The method further includes generating a digital twin representation of the environment using the dataset for the environment.

In addition to one or more of the features described herein, or as an alternative, further embodiments of the method may include that the camera is a 360 degree image acquisition system.

In addition to one or more of the features described herein, or as an alternative, further embodiments of the method may include that the 360 degree image acquisition system includes: a first photosensitive array operably coupled to a first lens, the first lens having a first optical axis in a first direction, the first lens being configured to provide a first field of view greater than 180 degrees; a second photosensitive array operably coupled to a second lens, the second lens having a second optical axis in a second direction, the second direction is opposite the first direction, the second lens being configured to provide a second field of view greater than 180 degrees; and wherein the first field of view at least partially overlaps with the second field of view.

In addition to one or more of the features described herein, or as an alternative, further embodiments of the method may include that the first optical axis and second optical axis are coaxial.

In addition to one or more of the features described herein, or as an alternative, further embodiments of the method may include that the first photosensitive array is positioned adjacent the second photosensitive array.

In addition to one or more of the features described herein, or as an alternative, further embodiments of the method may include that the processing system triggers the camera to capture the panoramic image with a trigger event.

In addition to one or more of the features described herein, or as an alternative, further embodiments of the method may include that the trigger event is an automatic trigger event or a manual trigger event.

In addition to one or more of the features described herein, or as an alternative, further embodiments of the method may include that the automatic trigger event is based on a location of the processing system, is based on a location of the camera, is based on an elapsed distance, or is based on an elapsed time.

In addition to one or more of the features described herein, or as an alternative, further embodiments of the method may include, subsequent to capturing the panoramic image of the environment, causing the camera to rotate.

In addition to one or more of the features described herein, or as an alternative, further embodiments of the method may include that capturing the panoramic image includes capturing a first panoramic image at a first location within the environment and capturing a second panoramic image at a second location within the environment.

In addition to one or more of the features described herein, or as an alternative, further embodiments of the method may include that the panoramic image is one of a plurality of images captured at a location of the environment, wherein the panoramic image is a 360 degree image.

In addition to one or more of the features described herein, or as an alternative, further embodiments of the method may include that a portion of each of the plurality of images is used to generate the dataset for the environment.

In addition to one or more of the features described herein, or as an alternative, further embodiments of the method may include selecting a point within the digital representation for performing a metrology task, wherein selecting the point includes processing the panoramic image to identify features onto which a point selection tool can snap.

In addition to one or more of the features described herein, or as an alternative, further embodiments of the method may include extracting a geometric feature based at least in part on the 3D coordinate data.

In another exemplary embodiment a system includes a panoramic camera to capture a panoramic image of an environment. The system further includes a processing system communicatively coupled to the panoramic camera. The processing system includes a light detecting and ranging (LIDAR) sensor, a memory having computer readable instructions, and a processing device for executing the computer readable instructions, the computer readable instructions controlling the processing device to perform operations. The operations include capturing three-dimensional (3D) coordinate data of an environment using the LIDAR sensor while the processing system moves through the environment. The operations further include causing the panoramic camera to capture a panoramic image of the environment. The operations further include generating a digital twin representation of the environment using the panoramic image and the 3D coordinate data.

In addition to one or more of the features described herein, or as an alternative, further embodiments of the system may include that the panoramic camera is mechanically and rigidly coupled to the processing system.

In addition to one or more of the features described herein, or as an alternative, further embodiments of the system may include that the panoramic camera is a 360 degree image acquisition system that includes: a first photosensitive array operably coupled to a first lens, the first lens having a first optical axis in a first direction, the first lens being configured to provide a first field of view greater than 180 degrees; a second photosensitive array operably coupled to a second lens, the second lens having a second optical axis in a second direction, the second direction is opposite the first direction, the second lens being configured to provide a second field of view greater than 180 degrees. The first field of view at least partially overlaps with the second field of view, the first optical axis and second optical axis are coaxial, and the first photosensitive array is positioned adjacent the second photosensitive array.

In addition to one or more of the features described herein, or as an alternative, further embodiments of the system may include that the processing system triggers the camera to capture the panoramic image with a trigger event, wherein the trigger event is an automatic trigger event or a manual trigger event, and wherein the automatic trigger event is based on a location of the processing system, is based on a location of the camera, is based on an elapsed distance, or is based on an elapsed time.

In addition to one or more of the features described herein, or as an alternative, further embodiments of the system may include that capturing the panoramic image includes capturing a first panoramic image at a first location within the environment and capturing a second panoramic image at a second location within the environment.

In another exemplary embodiment a method includes physically connecting a processing system to a rotary stage. The processing system includes a light detecting and ranging (LIDAR) sensor and a camera. The method further includes capturing, by the processing system, three-dimensional (3D) data of an environment using the LIDAR sensor while the processing system moves through the environment. The method further includes capturing, by the camera, a plurality of images of the environment. The method further includes generating, by the processing system, a panoramic image of the environment based at least in part on at least two of the plurality of images. The method further includes associating the panoramic image of the environment with the 3D coordinate data of the environment to generate a dataset for the environment. The method further includes generating a digital twin representation of the environment using the dataset for the environment.

In addition to one or more of the features described herein, or as an alternative, further embodiments of the method may include that at least one of the plurality of images of the environment is captured at a first location in the environment, and wherein another at least one of the plurality of images of the environment is captured at a second location in the environment.

In addition to one or more of the features described herein, or as an alternative, further embodiments of the method may include that the rotary stage is motorized.

In addition to one or more of the features described herein, or as an alternative, further embodiments of the method may include causing, by the processing system, the rotary stage to rotate by a certain amount.

In addition to one or more of the features described herein, or as an alternative, further embodiments of the method may include that the rotary stage is affixed to a mount or tripod.

In addition to one or more of the features described herein, or as an alternative, further embodiments of the method may include that a number of images captured as the plurality of images is based at least in part on a field of view of the camera or a field of view of the LIDAR sensor.

In addition to one or more of the features described herein, or as an alternative, further embodiments of the method may include that movement of the rotary stage and capturing the plurality of images are synchronized.

The above features and advantages, and other features and advantages, of the disclosure are readily apparent from the following detailed description when taken in connection with the accompanying drawings.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1A is a schematic block diagram of system to generate a digital twin representation of an environment or object, the system having a camera and a processing system having LIDAR capabilities according to one or more embodiments described herein;

FIG. 1B is a schematic view of an omnidirectional camera for use with the processing system of FIG. 1A according to one or more embodiments described herein;

FIG. 1C is a schematic view of an omnidirectional camera system with a dual camera for use with the processing system of FIG. 1A according to one or more embodiments described herein;

FIG. 1D and FIG. 1E are images acquired by the dual camera of FIG. 1C according to one or more embodiments described herein;

FIG. 1D′ and FIG. 1E′ are images of the dual camera of FIG. 1C where each of the images has a field of view greater than 180 degrees according to one or more embodiments described herein;

FIG. 1F is a merged image formed from the images of FIG. 1D and FIG. 1E in accordance with an embodiment according to one or more embodiments described herein;

FIG. 2 is a schematic block diagram of a system to generate a digital twin representation of an environment or object, the system having a camera and a processing system having LIDAR capabilities according to one or more embodiments described herein;

FIG. 3 is a flow diagram of a method for generating a digital twin representation of an environment according to one or more embodiments described herein;

FIG. 4A depicts a flow diagram of a method for generating a digital twin representation of an environment according to one or more embodiments described herein;

FIG. 4B depicts a flow diagram of a method for viewing a digital twin representation of an environment according to one or more embodiments described herein;

FIGS. 5A and 5B depict example digital twin representations of an environment according to one or more embodiments described herein;

FIG. 6 depicts a system having a processing system mounted or otherwise affixed to a rotary stage according to one or more embodiments described herein;

FIG. 7 depicts a flow diagram of a method for generating a digital twin representation of an environment using a processing system with an integral camera and LIDAR sensor according to one or more embodiments described herein; and

FIG. 8 depicts a flow diagram of a method for generating a digital twin representation of an environment using a processing system with an integral camera and LIDAR sensor according to one or more embodiments described herein.

The detailed description explains embodiments of the disclosure, together with advantages and features, by way of example with reference to the drawings.

### DETAILED DESCRIPTION OF THE DISCLOSURE

Embodiments of the present disclosure provide for using a camera, such as an ultra-wide angle camera for example, with a processing system having light detection and ranging (LIDAR) capabilities to generate a digital twin representation of an environment or object. Embodiments of the disclosure provide for using an image from the ultra-wide angle camera to enhance or increase the efficiency of a coordinate measurement device.

Digital twins are created by capturing data about a physical thing, such as an object or objects in an environment. The data can include three-dimensional (3D) coordinate data and/or image data. The 3D coordinate data be captured by a 3D coordinate measurement device (such as a 3D laser scanner time-of-flight (TOF) coordinate measurement device, a light detection and ranging (LIDAR) device, a photogrammetry device, etc.), a mobile mapping device, and/or the like, including combinations and/or multiples thereof. The image data can be captured by any suitable imaging device, such as a digital camera.

Conventionally, digital twins are created using specialized hardware and trained personnel to generate a visually appealing digital twin, which offers at least a desired level of measurement capabilities. However, these digital twins are costly in terms of time and effort to make and complex in terms of the specialized hardware needed to generate them. However, in some use cases, such as a virtual walkthrough, a digital twin with basic measurement capabilities (e.g., lengths, areas, volumes) is sufficient. Such use cases can include real estate, facilities management, contractor estimates, and/or the like, including combinations and/or multiples thereof.

In an effort to address these and other shortcomings of the prior art, one or more embodiments are provided herein for generating a digital twin representation of an environment or object using an ultra-wide angle camera with a coordinate measurement device. An example of such a coordinate measurement device is a LIDAR-enabled smartphone. The one or more embodiments described herein eliminate the costly and complex specialized hardware and trained personnel conventionally needed to generate a digital twin representation of an object or environment. This can be accomplished by using consumer-grade hardware (e.g., a cellular-phone/smartphone and/or a panoramic camera) to generate a digital twin of an environment or object. For example, one or more embodiments described herein can be used to generate a virtual walkthrough of an environment. Such a virtual walkthrough provides not only panoramic images but also 3D geometry of the environment (e.g., a mesh from the recorded 3D point cloud data by the smartphone). As used herein, the phrase “point cloud” means a plurality of 3D coordinate data in a common frame of reference. This plurality of 3D coordinate data may be visually displayed as a collection of points.

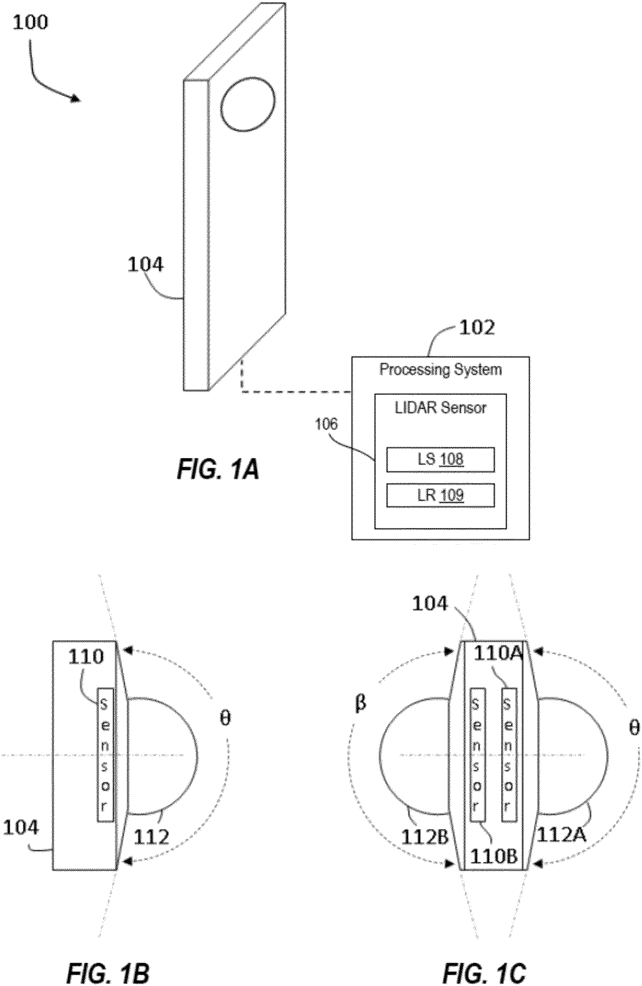

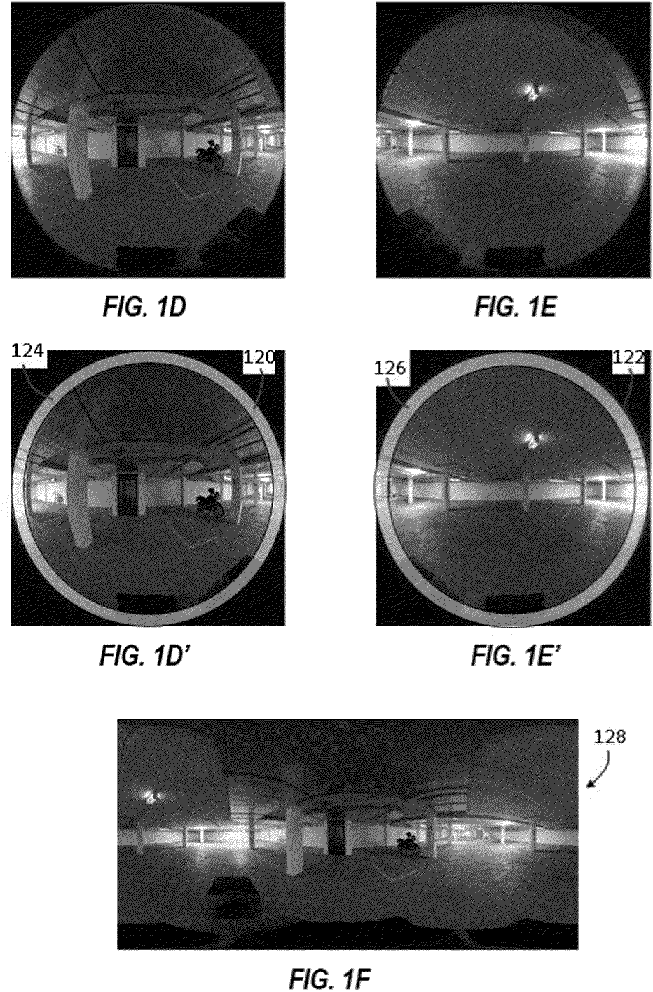

Referring now to FIGS. 1A – 1C, an embodiment is shown of a system 100 for generating a digital twin representation of an environment according to one or more embodiments described herein. Particularly, FIG. 1A depicts a system 100 to generate a digital twin representation of an environment or object, the system having a camera 104 and a processing system 102 having LIDAR capabilities. As an example, the processing system 102 can be a smartphone, laptop computer, tablet computer, and/or the like, including combinations and/or multiples thereof. As an example, the camera 104 can be an omnidirectional camera, such as the RICO THETA camera. The processing system 102 includes a LIDAR sensor 106 for measuring coordinates, such as three-dimensional coordinates, in an environment. The LIDAR sensor 106 can include a light source 108 and a light receiver 109. As discussed in more detail herein, the LIDAR sensor 106 is configured to emit light from the light source 108, the light being reflected off a surface in the environment. The reflected light is received by the light receiver 109. In an embodiment, the light receiver 109 of the LIDAR sensor 106 is a photosensitive array.

The processing system 102 can be any suitable processing system, such as a smartphone, tablet computer, laptop or notebook computer, etc. Although not shown, the processing system 102 can include one or more additional components, such as a processor for executing instructions, a memory for storing instructions and/or data, a display for displaying user interfaces, an input device for receiving inputs, an output device for generating outputs, a communications adapter for facilitating communications with other devices (e.g., the camera 104), and/or the like including combinations and/or multiples thereof.

The camera 104 captures one or more images, such as a panoramic image, of an environment. In examples, the camera 104 can be an ultra-wide angle camera 104. In an embodiment, the camera 104 includes a sensor 110 (FIG. 1B), that includes an array of photosensitive pixels. The sensor 110 is arranged to receive light from a lens 112. In the illustrated embodiment, the lens 112 is an ultra-wide angle lens that provides (in combination with the sensor 110) a field of view θ between 100 and 270 degrees, for example. In an embodiment, the field of view θ is greater than 180 degrees and less than 270 degrees about a vertical axis (e.g., substantially perpendicular to the floor or surface that the measurement device is located). It should be appreciated that while embodiments herein describe the lens 112 as a single lens, this is for example purposes and the lens 112 may be comprised of a plurality of optical elements.

In an embodiment, the camera 104 includes a pair of sensors 110A, 110B that are arranged to receive light from ultra-wide angle lenses 112A, 112B respectively (FIG. 1C). In this example, the camera 104 can be referred to as a dual camera because it has a pair of sensors 110A, 110B and lenses 112A, 112B as shown. The sensor 110A and lens 112A are arranged to acquire images in a first direction, and the sensor 110B and lens 112B are arranged to acquire images in a second direction. In the illustrated embodiment, the second direction is opposite the first direction (e.g., 180 degrees apart). A camera having opposingly arranged sensors and lenses with at least 180 degree field of view are sometimes referred to as an omnidirectional camera, a 360 degree camera, or a panoramic camera as it acquires an image in a 360 degree volume about the camera.

FIGS. 1D and 1E depict images acquired by the dual camera of FIG. 1C, for example, and FIGS. 1D′ and 1E′ depict images acquired the dual camera of FIG. 1C where each of the images has a field of view greater than 180 degrees. It should be appreciated that when the field of view is greater than 180 degrees, there will be an overlap 120, 122 between the acquired images 124, 126 as shown in FIG. 1D′ and FIG. 1E′. In some embodiments, the images may be combined to form a single image 128 of at least a substantial portion of the spherical volume about the camera 104 as shown in FIG. 1F.

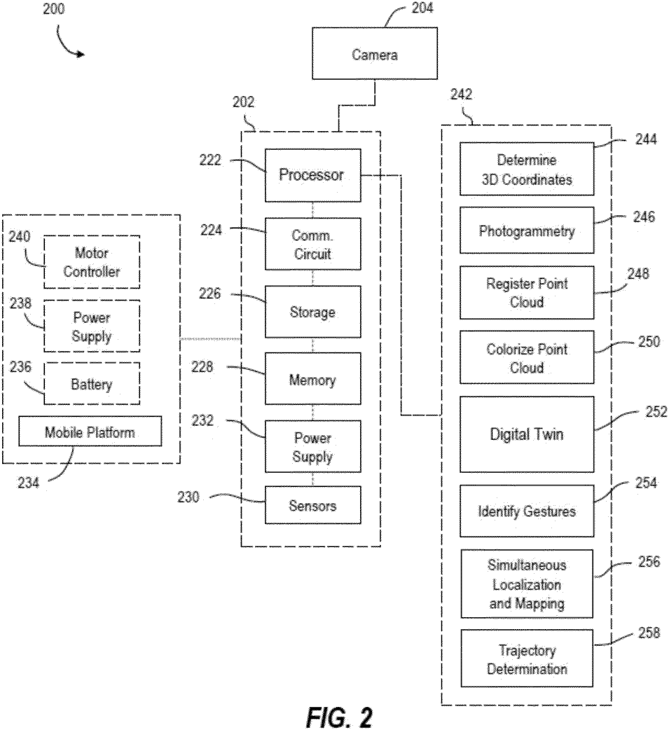

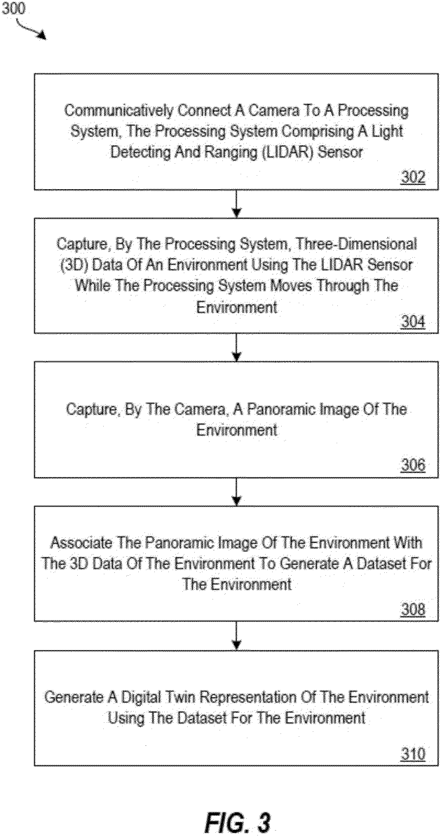

Referring now to FIG. 2, a schematic illustration of a system 200 is shown according to one or more embodiments described herein. In an embodiment, the system 200 is the same as (or similar to) the system 100 of FIG. 1A. In particular, the system 200 can generate a digital twin representation of an environment or object. The system 200 includes a camera 204 and a processing system 202 having LIDAR capabilities according to one or more embodiments described herein. The camera, also referred to as an image acquisition system, can be an omnidirectional camera, a 360 degree camera, or a panoramic camera that acquires an image in a 360 degree volume about the camera.

As an example, a user has a smartphone with an integrated LIDAR sensor (e.g., the processing system 202) as well as a panoramic camera (e.g., the camera 204). The smartphone is configured to track its position in an environment (e.g., using relative tracking and/or an alignment to an existing coordinate system) while the smartphone moves through the environment. During the movement, the LIDAR sensor, parallel to the tracking, records 3D coordinate data, which can be represented as a collection of 3D points (e.g., a 3D point cloud). This results in a point cloud representation of the environment. Additionally, with the panoramic camera (e.g., the camera 204), the user records panoramic images. These images have a position and orientation in the recorded 3D coordinate data from the smartphone. The collection of recorded panoramic images and the recorded 3D coordinate data (e.g., the 3D point cloud) of the environment can be used to generate a digital twin of the environment. The user can navigate freely in a walkthrough visualization i.e. the addressable virtual positions the user can choose are not restricted to the positions of the recorded panoramic images but for any selected position in the digital twin a panoramic view can be generated.

The processing system 202 and camera 204 are communicatively connected (i.e., communicatively coupled) together such that the camera 204 can send data (e.g., images) to the processing system 202, and the processing system 202 can send data (e.g., commands) to the camera 204. According to one or more embodiments described herein, the processing system 202 includes a processor 222 that provides for the operation of the system 200. In an embodiment, the processor 222 includes one or more processors that are responsive to executable computer instructions when executed on the one or more processors. It should be appreciated that one or more of the processors may be located remotely from the processing system 202. In an embodiment, the processor 222 uses distributed computing with some of the processing being performed by one or more nodes in a cloud-based computing environment. The processor 222 may accept instructions through a user interface (i.e., an input device), such as but not limited to a keyboard, a mouse, or a touch screen for example.

The processor 222 is capable of converting signals representative of system data received from the camera 204 and/or one or more sensors 230 of the processing system 202. The system data may include distance measurements and encoder signals that may be combined to determine three-dimensional coordinates on surfaces in the environment. Other system data may include images or pixel voltages from the camera 204. In general the processor 222 receives system data and is given certain instructions, which can cause one or more of generating a 3D coordinate, registering a plurality of coordinate systems, applying color to points in the point cloud, identifying retroreflective or reflective targets, identifying gestures, simultaneously localizing and generating a map of the environment, determining the trajectory of a measurement device, generating a digital twin of an object or environment, and/or the like, including combinations and/or multiples thereof.

The processor 222 also provides operating signals to the camera 204. For example, the signals may initiate control methods that adapt the operation of the processing system 202 and/or the camera 204, such as causing the camera 204 to capture one or more images.

The processor 222 is coupled to one or more system components by data transmission media (e.g., twisted pair wiring, coaxial cable, fiber optical cable, wireless protocols, and/or the like). Data transmission media includes, but is not limited to, wireless, radio, and infrared signal transmission systems. In the embodiment of FIG. 2, data transmission media couples to the processor 222 to the camera 204, a communications circuit 224, a storage device 226 (e.g., nonvolatile memory), a memory 228 (e.g., random access memory or read-only memory), and one or more sensors 230.

The communications circuit 224 is operable to transmit and receive signals between the camera 204 and the processing system 202 and/or from external sources, including but not limited to nodes in a distributed or cloud-based computing environment. The communications circuit 224 may be configured to transmit and receive signals wirelessly (e.g. WiFi or Bluetooth), via a wired connection (e.g. Ethernet, Universal Serial Bus), or a combination thereof.

The storage device 226 is any form of non-volatile memory such as an EPROM (erasable programmable read only memory) chip, a disk drive, and/or the like, including combinations and/or multiples thereof. Stored in storage device 226 are various operational parameters for the application code. According to one or more embodiments described herein, the storage device 226 can store position data associated with each image captured by the camera 204. According to one or more embodiments described herein, the storage device 226 can store the 3D coordinate data (e.g., point cloud data) captured by the LIDAR sensor during the tracking. According to one or more embodiments described herein the storage device 226 can store images captured by a camera (not shown) of the processing system 202, position data associated with the images captured by the camera of the processing system 202, and/or position data of annotations made by a user to the images captured by the camera of the processing system 202.

In an embodiment, the sensors 230 may include a LIDAR sensor, an inertial measurement unit, an integral camera or cameras, and/or the like including combinations and/or multiples thereof. For example, like the processing system 102 of FIG. 1A, the processing system 202 can also include a LIDAR sensor. As discussed in more detail herein, the LIDAR sensor (e.g., the sensor 230) can be configured to emit light from a light source, which is reflected off a surface in the environment, and the reflected light is received by a light receiver, such as a photosensitive array.

The processor 222 includes operation control methods embodied in application code, such as the methods described herein. These methods are embodied in computer instructions written to be executed by the one or more processors, typically in the form of software. The software can be encoded in any programming language. The processor 222 may further be electrically coupled to a power supply 232. The power supply 232 receives electrical power from a power source (e.g., a battery) and adapts the characteristics of the electrical power for use by the system 200.

In an embodiment, the system 200 may include a mobile platform 234. The mobile platform 234 may be any movable assembly capable of supporting the processing system 202 and/or the camera 204 during operation. As such, the mobile platform 234 can have wheels or articulated legs. In one or more embodiments, the mobile platform 234 may be, but is not limited to, a cart or a trolley for example. In other embodiments, the mobile platform 234 may be an airborne device, such as an unmanned aerial vehicle (UAV) or a drone for example. The mobile platform 234 may include a handle positioned for an operator to push or pull the mobile platform 234 through the environment where coordinates are to be acquired. In some embodiments, the mobile platform 234 may be autonomously or semi-autonomously operated. In this embodiment, the mobile platform 234 may include a power source/battery 236, a power supply 238, and a motor controller 240, although other configurations are also possible. In some examples, the mobile platform 234 is a tripod that can be positioned at and moved between different locations throughout an environment.

In an embodiment, the processor 222 is configured to execute one or more engines 242. In an embodiment, the engines 242 may be in the form of executable computer instructions that perform certain operational methods when executed on one or more processors. The engines 242 may be stored on the storage device 226 or the memory 228 for example. The engines 242 when executed on the processor 222 may receive inputs, such as from the one or more sensors 230 of the processing system 202 and/or from the camera 204, and transform data, generate data, and/or cause the processing system 202 and/or the camera 204 to perform an action. In an embodiment, the engines 242 include one or more of, but not limited to, a determine 3D coordinates engine 244, a photogrammetry engine 246, a register point cloud engine 248, a colorize point cloud engine 250, a digital twin engine 252, an identify gestures engine 254, a tracking engine 256, and a trajectory determination engine 258. It should be appreciated that, in examples, other engines can be utilized. For example, one or more of the engines 242 can be eliminated and/or one or more other engines can be added.

In an embodiment, the colorize point cloud engine 250 aligns the images acquired by the camera 204 with either the point cloud (from the register point cloud engine 248) or with the 3D points from individual scans. In either case, once aligned, the color values from the images may be mapped to the points and the color value assigned to the point. In this way, when the point cloud is displayed in color, the image will appear realistic.

In an embodiment, the photogrammetry engine 246 and the determine 3D coordinates engine 244 may cooperate to determine 3D coordinates of points on surfaces in the environment using the image(s) captured by the camera 204. In an embodiment, the register point cloud engine 248 may receive 3D coordinates from the engine 244 and register them into the same coordinate frame of reference based at least in part on image(s) acquired by the camera 204.

In an embodiment, the identify gestures engine 254 may receive an image from the omnidirectional camera 204. In respond to receiving the image, the engine 254 may perform image analysis to identify an operator within the image. Based at least in part on identifying the operator, the engine 254 may determine the operator is performing a gesture, such as by positioning their hands or their arms in a predetermined position (e.g. using a skeletal model). This predetermined position is compared with a table of operator positions and an associated control method is performed (e.g., measure 3D coordinates). In an embodiment, the identify gestures engine 254 operates in the manner described in commonly owned US Pat 8537371 entitled “Method and Apparatus for Using Gestures to Control a Laser Tracker”, the contents of which are incorporated by reference herein.

In an embodiment, the processing system 202 and the omnidirectional camera 204 are moved through the environment, such as on the mobile platform 234 or by an operator in hand. In an embodiment, a plurality of images are acquired by the camera 204 while the mobile platform 234 is moved through the environment. These plurality of images may be used to generate a two-dimensional (2D) map of the environment using a method such as simultaneous localization and mapping (SLAM) for example. According to one or more embodiments described herein, the tracking engine 256 using SLAM techniques to track the processing system 202. In other examples, the tracking engine 256 tracks the processing system 202 based on LIDAR data from the LIDAR sensor (e.g., the sensor 230) and/or based on images captured by a camera (not shown) integrated into the processing system 202.

The tracking engine 256 may cooperate with trajectory determination engine 258 to determine the trajectory (e.g., the 3D path) that the processing system 202 follows through the environment. In an embodiment, the determined trajectory is used by the register point cloud engine 248 to register the 3D coordinates in a common frame of reference.

According to one or more embodiments described herein, the processing system 202 can trigger the camera 204 to capture images. The triggering can be, for example, a manual triggering event (e.g., a user pressing a button on a touch screen of the processing system 202) and/or an automatic triggering event (e.g., every “X” seconds, every “X” distance, based on a predefined grid or predefined location, and/or the like, including combinations and/or multiples thereof).

According to one or more embodiments described herein, the processing system 202 can cause to be displayed, on a display (not shown) a trajectory (e.g., the trajectory from the trajectory determination engine 258, recorded 3D coordinate data (e.g., point cloud data), a confidence/completeness of the 3D coordinate data along with the 3D coordinate data, a mesh generation of the 3D coordinate data, an image trigger to cause multiple images to be captured, and/or the like including combinations and/or multiples thereof.

It should be appreciated that the camera 204 provides advantages to the engines 242 in allowing the control methods to be executed faster (e.g., less images are used) or perform methods that are not possible with traditional cameras with a narrower field of view.

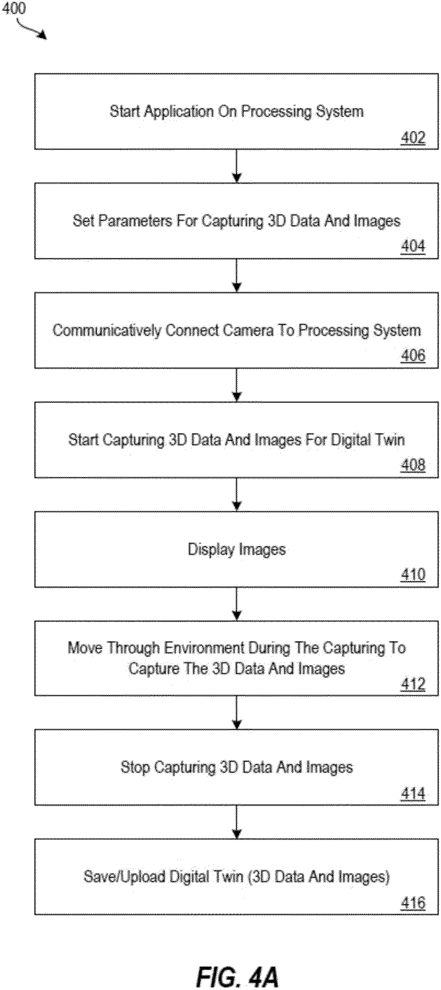

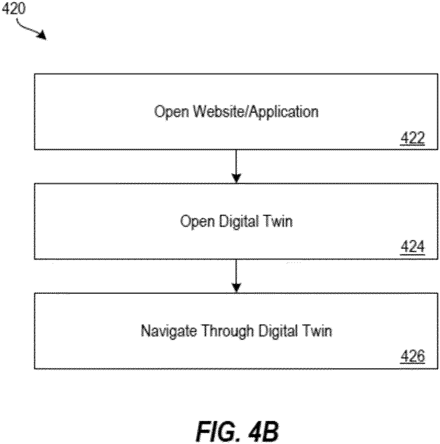

The digital twin engine 252 uses images captured by the camera 204 and data captured by the processing system 202 (e.g., from a LIDAR sensor) to generate a digital twin of the environment through with the camera 204 and the processing system 202 are moved. Further features and functionality of the system 100 and/or the system 200 are now described with reference to FIGS. 3, 4A, and 4B.

Particularly, FIG. 3 depicts a flow diagram of a method 300 for generating a digital twin representation of an environment according to one or more embodiments described herein. The method 300 can be performed by any suitable system and/or device, including combinations thereof. For example, the method 300 can be performed by the system 100 (including the processing system 102 and the camera 104), by the system 200 (including the processing system 202 and the camera 204), and/or the like.

At block 302, a camera, such as the camera 204 (e.g., a panoramic camera) is communicatively connected to a processing system, such as the processing system 202. The communicative connection (or “link”) can be any wired and/or wireless connection, such as a universal serial bus (USB) link, an ethernet link, a Bluetooth link, a WiFi link, a near-field communication link, and/or the like, including combinations and/or multiples thereof. As shown in FIGS. 1A and 2, the processing system can include a LIDAR sensor to collect data about an environment.

At block 304, the processing system, using the LIDAR sensor, captures 3D coordinate data of an environment while the processing system moves through the environment. For example, the processing system moves through the environment (e.g., is carried by a user, is mounted to and moved using a mobile platform, etc.) and captures 3D coordinate data about the environment using the LIDAR sensor. In an example, the camera is a 360 degree image acquisition system. In such an example, the 360 degree image acquisition system can include a first photosensitive array operably coupled to a first lens and a second photosensitive array operably coupled to a second lens. The first lens has a first optical axis in a first direction, and the first lens provides a first field of view greater than 180 degrees. Similarly, the second lens has a second optical axis in a second direction, the second direction being opposite the first direction. The second lens provides a second field of view greater than 180 degrees. The first field of view at least partially overlaps with the second field of view. According to one or more embodiments described herein, the first optical axis and the second optical axis are coaxial. According to one or more embodiments described herein, the first photosensitive array is positioned adjacent the second photosensitive array.

The camera can be triggered to capture by a trigger event, which can be an automatic trigger event or a manual trigger event, as described herein. For example, an automatic trigger event could be location-based (e.g., location of the camera and/or of the processing system), based on an elapsed amount of time, based on an elapsed distance (e.g., the distance that the camera and/or processing system traveled since the last image was captured), and/or the like, including combinations and/or multiples thereof.

At block 306, the camera captures an image (e.g., a panoramic image) of the environment. For example, the camera can be a panoramic camera, an omnidirectional camera, a 360 degree camera, or the like, as shown in FIGS. 1A-1C and as described herein. According to one or more embodiments described herein, the camera can capture multiple panoramic images. For example, at a first location of the environment, the camera can capture one or more panoramic images, then at a second location of the environment, the camera can capture one or more additional panoramic images.

At block 308, the processing system associates the panoramic image of the environment with the 3D coordinate data of the environment to generate a dataset for the environment. According to an embodiment, the panoramic image (e.g., a 360 degree image) is one of a plurality of images captured at a location of the environment, wherein the panoramic image is a 360 degree image. In some examples, a portion of each of the plurality of images is used to generate the dataset for the environment while in other examples, the entirety of each of the plurality of images is used to generate the dataset. By using only a portion of a plurality of images, certain items (e.g., an operator, a moving object, etc.) can be removed from the images.

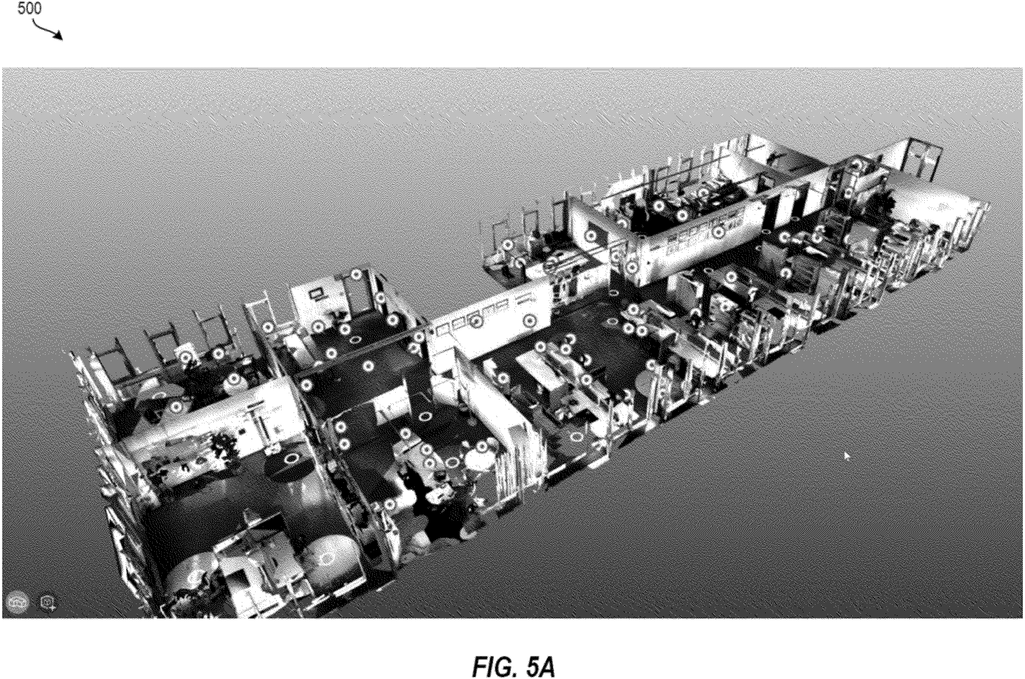

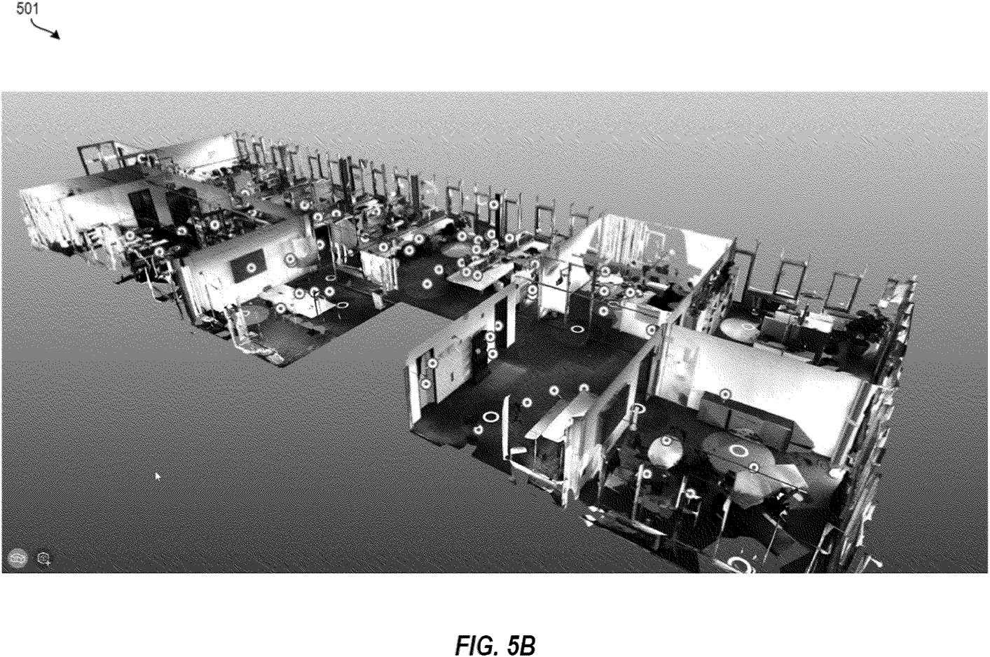

At block 310, the processing system generates a digital twin representation of the environment using the dataset for the environment. FIGS. 5A and 5B depict example digital twin representations 500, 501 of an environment according to one or more embodiments described herein. In this example, the digital twin representations 500, 501 can be referred to as “doll house views.” For constructing the doll house view (e.g., the digital twin representations 500, 501), a 3D geometry of the environment is being generated. As an example, this is accomplished by meshing a recorded point cloud from the 3D coordinate data collected by the LIDAR sensor of the processing system 202. The localized panoramic images are then projected onto the 3D geometry, as shown in FIGS. 5A and 5B.

With continued reference to FIG. 3, additional processes also may be included, and it should be understood that the process depicted in FIG. 3 represents an illustration, and that other processes may be added or existing processes may be removed, modified, or rearranged without departing from the scope of the present disclosure.

FIG. 4A depicts a flow diagram of a method 400 for generating a digital twin representation of an environment according to one or more embodiments described herein. The method 400 can be performed by any suitable system and/or device, including combinations thereof. For example, the method 400 can be performed by the system 100 (including the processing system 102 and the camera 104), by the system 200 (including the processing system 202 and the camera 204), and/or the like.

At block 402, an application is started on the processing system 202, the application being used to aid in the capture of 3D coordinate data by the processing system 202 and/or the capture of an image(s) by the camera 204.

At block 404, parameters are set on the application, the parameters defining criteria and/or preferences for capturing the 3D coordinate data and image(s). Examples of the parameters can include address, location, date and time, world coordinates, operator information, company information, resolution, number/spacing/quality settings, and/or the like, including combinations and/or multiples thereof.

At block 406, the camera 204 is communicatively connected to the processing system 202, such as using a wired and/or wireless link/communications-medium as described herein.

At block 408, the capture of 3D coordinate data and images for generating the digital twin begins. For example, the processing system 202, using the LIDAR sensor, begins capturing 3D coordinate data as the processing system 202 is moved through the environment. At various points throughout the environment, the camera 204 captures images (e.g., panoramic images) of the environment.

At block 410, the images are displayed, such as on a display of the processing system 202. For example, panoramic images can be displayed for preview purposes during the capturing of 3D coordinate data and/or capturing of the images. This gives the operator the ability to evaluate the images and determine their sufficiency and/or alter the images, such as renaming the images, retaking an image, etc.

At block 412, the processing system 202 and the camera 204 are moved through the environment during the capturing to capture the 3D coordinate data and the images for the digital twin. This can include, for example, steering/moving a field of view of the LIDAR sensor of the processing system 202 towards regions of interest, positioning the camera 204 in a position for desirable data capture, and/or the like. Feedback can be provided in some examples in case of speed errors (e.g., moving too slow or too fast), turning errors (e.g., turning too slow or too fast), loss of tracking, and/or the like.

At block 414, the capturing of 3D coordinate data and image(s) stops. This can be done manually or automatically.

At block 416, the captured 3D coordinate data and images are saved and/or uploaded, such as to a remote processing system (e.g., a cloud computing system). The saving/uploading can be triggered automatically when the capturing stops, for example, or triggered manually by a user.

According to one or more embodiments described herein, the captured 3D coordinate data and images are used to generate the digital twin representation of the environment. The digital twin representation can be, for example, a virtual walkthrough (see, e.g., FIGS. 5A and 5B). The generation of the digital twin representation can be based on the recorded panoramic image(s), locations estimated for these panoramic images (based on tracking, for example), and/or based on the recorded 3D (e.g., point cloud) data. This provides for free navigation in the digital twin representation.

According to one or more embodiments described herein, the digital twin representation can be used to perform metrology tasks. For example, a pixel in a panoramic image can be selected, and the 3D coordinate of this pixel (based on the recorded 3D coordinate data (e.g., point cloud) can be determined. According to one or more embodiments described herein, a snipping measurement line can be generated relative to a pre-defined axis (X,Y,Z).

According to one or more embodiments described herein, the digital twin representation can be aligned in a coordinate (X,Y,Z) system.

According to one or more embodiments described herein, the 3D coordinate data, once captured, can be cleaned up and optimized, such as to remove redundant points, to fill in missing points, to align scans from different locations within the environment, and/or the like, including combinations and/or multiples thereof.

According to one or more embodiments described herein, a mesh can be created from the 3D coordinate data (e.g., point cloud). In some examples, the mesh can be refined using photogrammetric techniques, such as a semi-global matching in object space. Using such techniques, for example, vortices of the mesh can be virtually projected in to possible (panoramic) images. A color or feature comparison can be performed, which determines an error value that can be minimized by finding an optimized position for the mesh vortex.

According to one or more embodiments described herein, positions for the panoramic images, relative to the environment, can be refined based on image content and the captured 3D coordinate data. In some examples, the refinement can be based on dimensions of the fixture.

According to one or more embodiments described herein, the panoramic image can be optimized. Such optimization can include one or more of the following, for example, color optimization high dynamic range calculation, removal of artifacts (e.g., moving objects), combining multiple images captured at the same location into one corrected image, and/or the like, including combinations and/or multiples thereof.

Additional processes also may be included, and it should be understood that the process depicted in FIG. 4A represents an illustration, and that other processes may be added or existing processes may be removed, modified, or rearranged without departing from the scope of the present disclosure.

FIG. 4B depicts a flow diagram of a method for viewing a digital twin representation of an environment according to one or more embodiments described herein. The method 400 can be performed by any suitable system and/or device, including combinations thereof. For example, the method 400 can be performed by the processing system 102, by the processing system 202, and/or the like.

At block 422, a user opens a website and/or application on the processing system 202. For example, a user may navigate to a website using a uniform resource locator (URL), and the user may enter login credentials (e.g., a combination of a username and password) to enter the website. Once on the website, the user can access existing digital twins for which the user has permissions. The user can open a project having multiple digital twin representations and/or open a specific digital twin representation at block 424, such as by typing in the name of a project or digital twin representation, selecting a project or digital twin representation, and/or the like. At block 426, the user can virtually navigate through the digital twin representation. For example, the user can visualize the environment represented by the digital twin representation, such as on a display of the processing system 202, on a head-up display (HUD), and/or on any other suitable display. According to one or more embodiments described herein, the digital twin representation can be displayed as a virtual reality element using a virtual reality system. The user can manipulate the digital twin representation, such as by using gestures, touch inputs on a touch screen, a mouse/keyboard, and/or the like, to cause the digital twin representation to change its field of view. As another example, the user can “move” to different virtual locations within the digital twin representation. The user can also change aspects of the digital twin representation displayed to the user, such as by causing the digital twin representation to zoom, pan, tilt, rotate, and/or the like, including combinations and/or multiples thereof.

Additional processes also may be included, and it should be understood that the process depicted in FIG. 4B represents an illustration, and that other processes may be added or existing processes may be removed, modified, or rearranged without departing from the scope of the present disclosure.

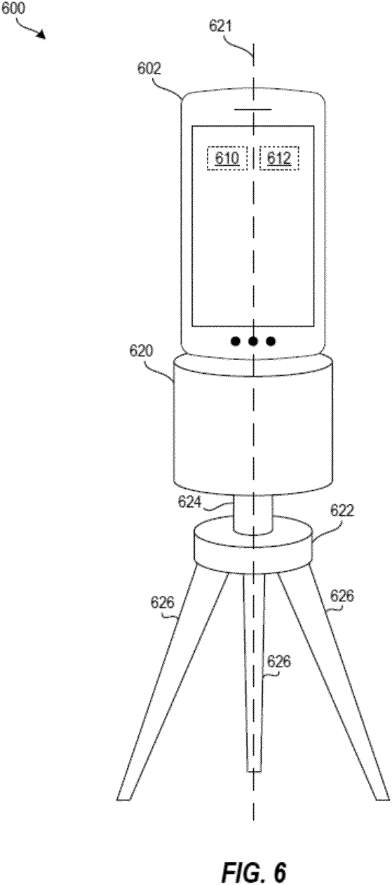

According to one or more embodiments described herein, the processing system 202 can be a smartphone (or the like) having an integral camera and LIDAR sensor. In such an embodiment, the smartphone, using its integral camera and LIDAR sensor, can capture the images and 3D coordinate data used to generate the digital twin representation. For example, FIG. 6 shows a system 600 having a processing system 602 mounted or otherwise affixed to a rotary stage 620 according to one or more embodiments described herein. In such examples, a camera 610 (or cameras) integral to the processing system 602 (and separate from the camera 204) can be used to capture images of the environment. Multiple of the images can be combined together to create a panoramic and/or 360 degree image of the environment. The processing system 602 also includes a LIDAR sensor 612 to capture 3D coordinate data about the environment, which can be used to generate a point cloud of the environment. Such embodiments can be used to generate a digital twin without a separate camera, such as the camera 204, by using the images from the integral camera 610 and the 3D coordinate data from the LIDAR sensor 612.

For example, a user has a processing system, such as a smartphone, with an integrated LIDAR sensor and camera (e.g., the processing system 602) as well as a rotary stage (e.g., the rotary stage 620). The smartphone is configured to track its position in an environment, using relative tracking for example (e.g., using one or more of ARKit by APPLE, ARCore by GOOGLE, and/or the like, including combinations and/or multiples thereof), as the smartphone moves through the environment. While the smartphone tracking occurs, the LIDAR sensor 612 records 3D coordinate data about the environment, which can be used to create a point cloud representation of the environment. Additionally, at selected locations in the environment, the smartphone is mounted on the rotary stage and is configured to record multiple images at different angular positions of the rotary stage. That is, the rotary stage rotates about an axis, and the smartphone, using its integrated camera, captures images at different angular positions. A set of images recorded during one rotation at a single location may treated as or used to form a panoramic image. According to one or more embodiments described herein, the number of images per rotation can be determined by a field of view of the camera 610 and/or a field of view of the LIDAR sensor 612. For example, an angular coverage of a rotation between two images can be calculated from a known horizontal field of view of the camera 610 (e.g., 50% of the horizontal field of view, 75% of the horizontal field of view, etc.)

According to one or more embodiments described herein, movement (e.g., rotation) of the rotary stage 620 can be synchronized with the capturing of images. According to one or more embodiments described herein, a communicative communication can be provided between the rotary stage 602 and the processing system 602 to provide for one or more of these devices to send signals to the other device on their current state. For example, a still standing rotary stage signals to the processing system that a photo can be captured, while a moving rotary stage does not give such a signal.

In one or more examples, the rotary stage 620 can be a motorized rotary stage that can rotate about an axis 621 using a stepper motor for example. The rotary stage 620 can be rotated manually and/or automatically, such as by the processing system 602, by an integral controller (not shown), and/or by any other suitable system or device, including combinations and/or multiples thereof. The rotary stage 620 can include an interface for facilitating communications with the processing system 602 and/or another device/system. Such an interface can support wired (e.g., USB) and/or wireless (e.g., Bluetooth) connections. According to one or more embodiments described herein, the rotary stage 620 can include an angular encoder that measures angular position of the stepper motor as it rotates. The angular position can be transmitted to the processing system 602 in one or more examples, such as for each captured image. The angular position may be useful to associated the image with the 3D coordinate data, to create a panoramic image from multiple images, and/or the like.

The rotary stage 620 can be mounted on or otherwise removably or permanently affixed to a mount, such as a tripod 622, at a connector 624. The tripod 622 includes three legs 626, although other types and/or configurations of mounts can be used. According to one or more embodiments described herein, the connector 624 can be integrally formed on the tripod 622 and configured to removably connect to the rotary stage 620. According to one or more embodiments described herein, the connector 624 can be integrally formed on the rotary stage 620 and configured to removably connect to the tripod 622. According to one or more embodiments described herein, the connector 624 can be an independent connector that is configured to removably connect to the tripod 622 and to the rotary stage 620.

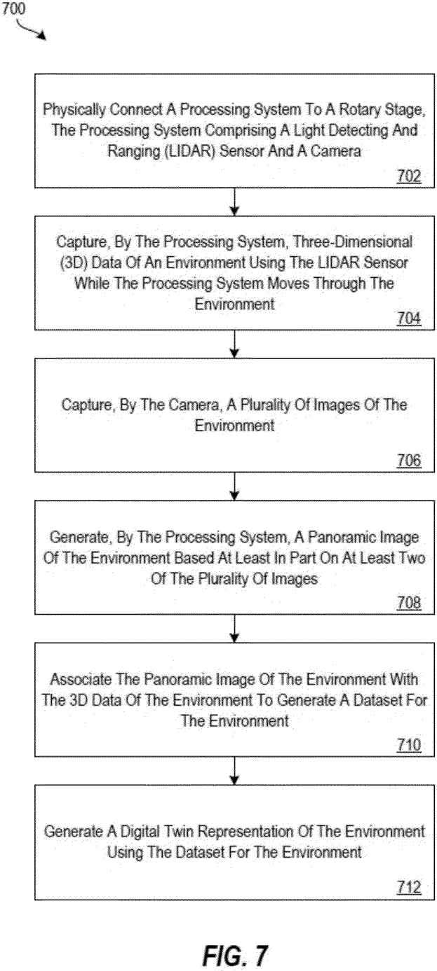

An example method for generating a twin representation of an environment using a processing system with an integral camera and LIDAR sensor is now described. Particularly, FIG. 7 depicts a flow diagram of a method 700 for generating a digital twin representation of an environment using a processing system (e.g., the processing system 602) with an integral camera (e.g., the camera 610) and LIDAR sensor (e.g., the LIDAR sensor 612) according to one or more embodiments described herein. The method 700 can be performed by any suitable system and/or device such as the processing system 102, the processing system 202, the processing system 602, and/or the like, including combinations and/or multiples thereof.

At block 702, a processing system (e.g., the processing system 602) is physically connected to a rotary stage (e.g., the rotary stage 620). The processing system includes a LIDAR sensor (e.g., the LIDAR sensor 612) and a camera (e.g., the camera 610). At block 704, the processing system processing system captures 3D coordinate data of an environment using the LIDAR sensor while the processing system moves through the environment. At block 706, the camera captures a plurality of images of the environment.

At block 708, the processing system generates a panoramic image of the environment based at least in part on at least two of the plurality of images. For example, the processing system, using its camera, can capture multiple images at each of multiple locations in an environment (e.g., a first set of images at a first location and a second set of images at a second location). The images for each location can be used to generate a panoramic image for that location (e.g., the first set of images are used to generate a panoramic image for the first location). According to one or more embodiments described herein, the creation of full panoramic images from individual images can be based on the image content (e.g., align images based on features within the images), based on the 3D coordinate data from the LIDAR sensor, based on motor control information from the rotary scanner (e.g., based on encoder readings from the angular encoder of the rotary stage), and/or the like, including combinations and/or multiples thereof. As an example, the final panoramic image may have an angular coverage of approximately 180 degrees in a first direction (e.g., vertically) and approximately 360 degrees in a second direction orthogonal to the first direction (e.g., horizontally). As another example, the final panoramic image may have an angular coverage of approximately 90 degrees in a first direction and approximately 360 degrees in a second direction. The stitching together of individual images to create the final panoramic image can be based at least in part on the 3D coordinate data collected by the LIDAR sensor, for example.

At block 710, the panoramic image of the environment is associated with the 3D coordinate data of the environment to generate a dataset for the environment. This can be done, for example, by the processing system 602, by a cloud computing system, and/or any other suitable device and/or system, including combinations and/or multiples thereof. At block 712, a digital twin representation of the environment is generated using the dataset for the environment. This can be done, for example, by the processing system 602, by a cloud computing system, and/or any other suitable device and/or system, including combinations and/or multiples thereof.

According to one or more embodiments described herein, the 3D coordinate data captured by the LIDAR sensor 612 can be used to create 2.5 dimensional images using the images captured by the camera 610. For example, the processing system 602 can cause (trigger) the recording of a 2.5D image when the rotary stage 620 is not moving. As used herein, a 2.5D image is a graphical image with depth information associated with one or more pixels. This can be detected by tracking as described herein, as reported by a controller (not shown) of the rotary stage 620, based on encoder readings from the angular encoder, and/or manually initiated.

According to one or more embodiments described herein, the stitching of panoramic images can be performed. For example, such refinement can be based on the 3D coordinate data.

Additional processes also may be included, and it should be understood that the process depicted in FIG. 7 represents an illustration, and that other processes may be added or existing processes may be removed, modified, or rearranged without departing from the scope of the present disclosure.

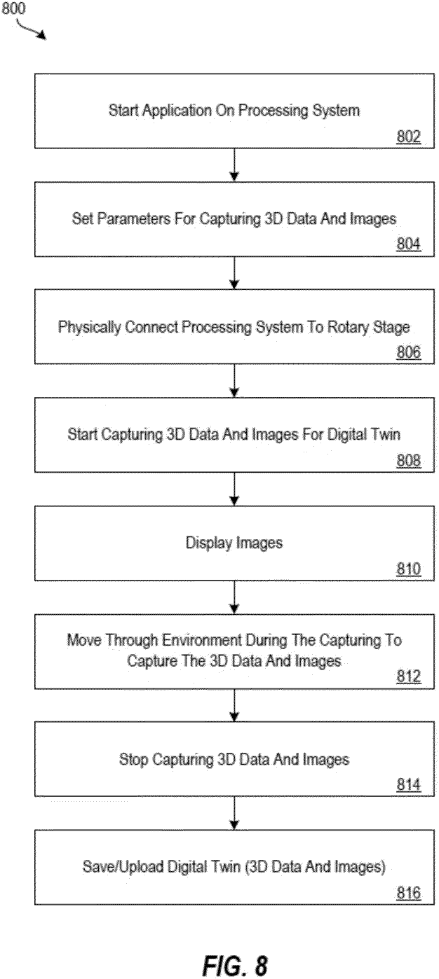

FIG. 8 depicts a flow diagram of a method 800 for generating a digital twin representation of an environment using a processing system (e.g., the processing system 602) with an integral camera (e.g., the camera 610) and LIDAR sensor (e.g., the LIDAR sensor 612) according to one or more embodiments described herein. The method 700 can be performed by any suitable system and/or device such as the processing system 102, the processing system 202, the processing system 602, and/or the like, including combinations and/or multiples thereof.

At block 802, an application is started on the processing system 602, the application being used to aid in the capture of 3D coordinate data by the LIDAR sensor 612 and/or the capture of an image(s) by the camera 610.

At block 804, parameters are set on the application, the parameters defining criteria and/or preferences for capturing the 3D coordinate data and image(s). Examples of the parameters can include address, location, date and time, world coordinates, operator information, company information, resolution, number/spacing/quality settings, and/or the like, including combinations and/or multiples thereof.

At block 806, the processing system 602 is physically connected to the rotary stage 620.

At block 808, the capture of 3D coordinate data and images for generating the digital twin begins. For example, the processing system 602, using the LIDAR sensor 612, begins capturing 3D coordinate data as the processing system 602 is moved through the environment. At various points throughout the environment, the combination of the processing system 602 and the rotary stage 620 are placed. While places, the processing system 602, using the camera 610, captures images of the environment. These images can be treated as or used to generate a panoramic and/or 360 degree image of the environment at the location in the environment where the images were captured.

At block 810, the images are displayed, such as on a display (not shown) of the processing system 602. For example, panoramic images can be displayed for preview purposes during the capturing of 3D coordinate data and/or capturing of the images. This gives the operator the ability to evaluate the images and determine their sufficiency and/or alter the images, such as renaming the images, retaking an image, etc.

At block 812, the processing system 602 is moved through the environment during the capturing to capture the 3D coordinate data and the images for the digital twin. This can include, for example, steering a field of view of the LIDAR sensor 612 of the processing system 602 towards regions of interest, positioning the processing system 602 in a position for desirable data and/or capture, and/or the like. Feedback can be provided in some examples in case of speed errors (e.g., moving too slow or too fast), turning errors (e.g., turning too slow or too fast), loss of tracking, and/or the like.

At block 814, the capturing of 3D coordinate data and image(s) stops. This can be done manually or automatically.

At block 816, the captured 3D coordinate data and images are saved and/or uploaded, such as to a remote processing system (e.g., a cloud computing system). The saving/uploading can be triggered automatically when the capturing stops, for example, or triggered manually by a user.

The digital twin representation can be viewed according to one or more embodiments described herein (see, e.g., the method 420 of FIG. 4B).

Additional processes also may be included, and it should be understood that the process depicted in FIG. 8 represents an illustration, and that other processes may be added or existing processes may be removed, modified, or rearranged without departing from the scope of the present disclosure.

As described herein, the digital twin representation may be used to perform metrology tasks according to one or more embodiments described herein. To performing metrology tasks (e.g., measuring a distance between two points), points are selected, such as from the digital twin representation. However, not all pixels in the captured images have an attribute (accurate) 3D coordinate data point associated therewith from the LIDAR sensor data. Further, the selection of a specific point in a panoramic image or walkthrough viewer (see, e.g., FIGS. 5A and 5B) can be error prone.

Accordingly, one or more embodiments described herein provide for point selection as follows. In an example, the images can be processed to identify features, such as corners, edges, areas, etc. onto which a point selection tool can snap. In an example, geometric features can be extracted based at least in part on the 3D point cloud data.

In some cases, a measurement marker can be placed within the environment. Such markers act as references because their locations are generally known. Markers are detected in the image/LIDAR data but may be incorrectly located. One or more embodiments described herein provide for correcting the placement of a marker after it is placed by moving it freely in the image(s), moving it along a specified axis in the image(s), moving it along an extracted edge in the image(s), and/or the like, including combinations and/or multiples thereof. In some examples, a measurement marker snaps to 3D points in the point cloud rather than pixels in the image. In such an example, a selected 3D point is projected back into the image for visualization of the marker. The point cloud (i.e., 3D coordinate data) may be densified in the selected region by interpolation to allow for a refined marker selection. According to one or more embodiments described herein, interpolation is pursued along or at extracted features, such as along an edge, at a corner (defined as intersection of edges and/or lines), and/or the like, including combinations and/or multiples thereof. According to one or more embodiments described herein, a measurement marker snaps to a pixel or feature in the image and the 3D coordinate is generated based on the underlying mesh representation of the point cloud.

The term “about” is intended to include the degree of error associated with measurement of the particular quantity based upon the equipment available at the time of filing the application.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.” It should also be noted that the terms “first”, “second”, “third”, “upper”, “lower”, and the like may be used herein to modify various elements. These modifiers do not imply a spatial, sequential, or hierarchical order to the modified elements unless specifically stated.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A method comprising:
communicatively connecting a camera to a processing system, the processing system comprising a light detecting and ranging (LIDAR) sensor;
capturing, by the processing system, three-dimensional (3D) coordinate data of an environment using the LIDAR sensor while the processing system moves through the environment;
capturing, by the camera, a panoramic image of the environment;
associating the panoramic image of the environment with the 3D coordinate data of the environment to generate a dataset for the environment; and
generating a digital twin representation of the environment using the dataset for the environment.

2. The method of claim 1, wherein the camera is a 360 degree image acquisition system.

3. The method of claim 2, wherein the 360 degree image acquisition system comprises:
a first photosensitive array operably coupled to a first lens, the first lens having a first optical axis in a first direction, the first lens being configured to provide a first field of view greater than 180 degrees;
a second photosensitive array operably coupled to a second lens, the second lens having a second optical axis in a second direction, the second direction is opposite the first direction, the second lens being configured to provide a second field of view greater than 180 degrees; and
wherein the first field of view at least partially overlaps with the second field of view.

4. The method of claim 3, wherein the first optical axis and second optical axis are coaxial.

5. The method of claim 3, wherein the first photosensitive array is positioned adjacent the second photosensitive array.

6. The method of claim 1, wherein the processing system triggers the camera to capture the panoramic image with a trigger event.

7. The method of claim 6, wherein the trigger event is an automatic trigger event or a manual trigger event.

8. The method of claim 7, wherein the automatic trigger event is based on a location of the processing system, is based on a location of the camera, is based on an elapsed distance, or is based on an elapsed time.

9. The method of claim 6, further comprising, subsequent to capturing the panoramic image of the environment, causing the camera to rotate.

10. The method of claim 1, wherein capturing the panoramic image comprises capturing a first panoramic image at a first location within the environment and capturing a second panoramic image at a second location within the environment.

11. The method of claim 1, wherein the panoramic image is one of a plurality of images captured at a location of the environment, wherein the panoramic image is a 360 degree image.

12. The method of claim 11, wherein a portion of each of the plurality of images is used to generate the dataset for the environment.

13. The method of claim 1, further comprising:
selecting a point within the digital representation for performing a metrology task, wherein selecting the point comprises processing the panoramic image to identify features onto which a point selection tool can snap.

14. The method of claim 1, further comprising extracting a geometric feature based at least in part on the 3D coordinate data.

15. A system comprising:
a panoramic camera to capture a panoramic image of an environment; and
a processing system communicatively coupled to the panoramic camera, the processing system comprising:
a light detecting and ranging (LIDAR) sensor;
a memory comprising computer readable instructions; and
a processing device for executing the computer readable instructions, the computer readable instructions controlling the processing device to perform operations comprising:
capturing three-dimensional (3D) coordinate data of an environment using the LIDAR sensor while the processing system moves through the environment;
causing the panoramic camera to capture a panoramic image of the environment; and
generating a digital twin representation of the environment using the panoramic image and the 3D coordinate data.

16. The system of claim 15, wherein the panoramic camera is mechanically and rigidly coupled to the processing system.

17. The system of claim 15, wherein the panoramic camera is a 360 degree image acquisition system that comprises:
a first photosensitive array operably coupled to a first lens, the first lens having a first optical axis in a first direction, the first lens being configured to provide a first field of view greater than 180 degrees;
a second photosensitive array operably coupled to a second lens, the second lens having a second optical axis in a second direction, the second direction is opposite the first direction, the second lens being configured to provide a second field of view greater than 180 degrees;
wherein the first field of view at least partially overlaps with the second field of view,
wherein the first optical axis and second optical axis are coaxial, and
wherein the first photosensitive array is positioned adjacent the second photosensitive array.

18. The system of claim 15, wherein the processing system triggers the camera to capture the panoramic image with a trigger event, wherein the trigger event is an automatic trigger event or a manual trigger event, and wherein the automatic trigger event is based on a location of the processing system, is based on a location of the camera, is based on an elapsed distance, or is based on an elapsed time.

19. The system of claim 15, wherein capturing the panoramic image comprises capturing a first panoramic image at a first location within the environment and capturing a second panoramic image at a second location within the environment.

20. A method comprising:
physically connecting a processing system to a rotary stage, the processing system comprising a light detecting and ranging (LIDAR) sensor and a camera;
capturing, by the processing system, three-dimensional (3D) data of an environment using the LIDAR sensor while the processing system moves through the environment;
capturing, by the camera, a plurality of images of the environment;
generating, by the processing system, a panoramic image of the environment based at least in part on at least two of the plurality of images;
associating the panoramic image of the environment with the 3D coordinate data of the environment to generate a dataset for the environment; and
generating a digital twin representation of the environment using the dataset for the environment.
